(19) United States
(12) Patent Application Publication
(10) Pub. No.: US 2021/0125338 A1
(43) Pub. Date: Apr. 29, 2021

(54) METHOD AND APPARATUS FOR COMPUTER VISION

(71) Applicant: Nokia Technologies Oy, Espoo (FI)

(72) Inventor: Zhijie Zhang, Tianjin (CN)

(21) Appl. No.: 17/057,187

(22) PCT Filed: May 24, 2018
(86) PCT No.: PCT/CN2018/088125

§ 371 Date: Nov. 20, 2020

(51) Int. Cl. G06T 7/11; G06K 9/46; G06N 3/08; G06K 9/34; G06K 9/62

(52) U.S. Cl. CPC G06T 7/11; G06K 9/4628; G06K 9/6269; G06K 9/34; G06K 9/6256; G06N 3/084

(57) ABSTRACT

Method and apparatus are disclosed for computer vision. The method may comprise processing, by using a neural network, first input feature maps of an image to obtain output feature maps of the image. The neural network may comprise at least two branches and a first addition block, each of the at least two branches comprises at least one first dilated convolution layer, at least one first upsampling block and at least one second addition block, a dilated rate of the first dilated convolution layer in an branch is different from that in another branch, the at least one first upsampling block is configured to upsample the first input feature maps or the feature maps output by the at least one second addition block, the at least one second addition block is configured to add the upsampled feature maps with second input feature maps of the image respectively, the first addition block is configured to add the feature maps output by each of the at least two branches, the first dilated convolution layer has one convolution kernel and an input channel of the first dilated convolution layer performs dilated convolution separately as an output channel of the first dilated convolution layer.

### FIELD OF THE INVENTION

Embodiments of the disclosure generally relate to information technologies, and, more particularly, to computer vision.

### BACKGROUND

Computer vision is a field that deals with how computers can be made for gaining high-level understanding from digital images or videos. Computer vision plays an important role in many applications. Computer vision systems are broadly used for various vision tasks such as scene reconstruction, event detection, video tracking, object recognition, semantic segmentation, three dimensional (3D) pose estimation, learning, indexing, motion estimation, and image restoration. As an example, computer vision systems can be used in video surveillance, traffic surveillance, driver assistant systems, autonomous vehicle, traffic monitoring, human identification, human-computer interaction, public security, event detection, tracking, frontier guards and the Customs, scenario analysis and classification, image indexing and retrieve, and etc.

Semantic segmentation is tasked with classifying a given image at pixel-level to achieve an effect of object segmentation. The process of semantic segmentation is to segment an input image into regions, which are classified as one of the predefined classes.

The technology of semantic segmentation has wide practical applications in semantic parsing, scene understanding, human-machine interaction (HMI), visual surveillance, Advanced Driver Assistant Systems (ADAS), unmanned aircraft system (UAS), and so on. Applying semantic segmentation on captured images, an image may be segmented into semantic regions, of which the class labels (e.g., pedestrians, cars, buildings, tables, flowers) of the image are known. When a proper query is given, object-of-interest, region-of-interest with the segmented information can be efficiently searched.

In the application of autonomous vehicles, understanding the scene such as road scene may be necessary. Given a captured image, the vehicle is required to be capable of recognizing available road, lanes, lamps, persons, traffic signs, building, etc., and then the vehicle can take proper driving operation according to recognition results. The driving operation may have a dependency on a high performance of semantic segmentation. As shown in FIG. 1, a camera located on a top of a car captures an image. A semantic segmentation algorithm may segment scene in the captured image into regions with 12 classes: sky, building, pole, road marking, road, pavement, tree, sign symbol, fence, vehicle, pedestrian, and bike. The contents of the scene may provide the guideline for the car to prepare next operation.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Deep learning plays an effective role in strengthening the performance of semantic segmentation approaches. For instance, deep convolutional network based on spatial pyramid pooling (SPP) has been used in semantic segmentation. In semantic segmentation, SPP consists of several parallel feature-extracted layers and a fusion layer. The parallel feature-extracted layers are used to capture feature maps of different receptive field while the fusion layer is to probe information of different receptive field.

Traditional semantic segmentation networks based on SPP usually perform SPP for feature extracting at a low resolution, and then directly upsample the results by a large rate to an original input resolution for final predictions. However there are some problems of traditional semantic segmentation networks based on SPP as follows:
Traditional semantic segmentation networks perform SPP at a low resolution, which results poor extracted features.
Traditional semantic segmentation networks perform upsampling on the feature maps by a large rate, which results serious grid effect and poor visual quality.
Traditional semantic segmentation networks may cause excessive parameters and information redundancy.

To overcome or mitigate at least one of the above-mentioned problems or other problems, some embodiments of the disclosure propose a neural network termed as Robust Spatial Pyramid Pooling (RSPP) neural network which can be applied to various vision tasks, such as image classification, object detection and semantic segmentation. The proposed RSPP neural network upsample the feature maps of parallel convolution layers in Spatial Pyramid Pooling (SPP) by a proper rate, fuse with low-level feature maps which contain detailed object information and then perform convolution again. RSPP neural network removes a normal convolution by mixing depth-wise convolution with dilated convolution (termed as depth-wise dilated convolution). RSPP neural network is able to yield a better performance.

According to an aspect of the present disclosure, it is provided a method. The method may comprise processing, by using a neural network, first input feature maps of an image to obtain output feature maps of the image. The neural network may comprise at least two branches and a first addition block, each of the at least two branches comprises at least one first dilated convolution layer, at least one first upsampling block and at least one second addition block, a dilated rate of the first dilated convolution layer in an branch is different from that in another branch, the at least one first upsampling block is configured to upsample the first input feature maps or the feature maps output by the at least one second addition block, the at least one second addition block is configured to add the upsampled feature maps with second input feature maps of the image respectively, the first addition block is configured to add the feature maps output by each of the at least two branches, the first dilated convolution layer has one convolution kernel and an input channel of the first dilated convolution layer performs dilated convolution separately as an output channel of the first dilated convolution layer.

In an embodiment, each of the at least two branches may further comprise a second dilated convolution layer configured to process the first input feature maps and send its output feature maps to the first upsampling block, the second dilated convolution layer has one convolution kernel and an input channel of the second dilated convolution layer performs dilated convolution separately as an output channel of the second dilated convolution layer.

In an embodiment, the neural network may further comprise a first convolution layer configured to reduce a number of the first input feature maps.

In an embodiment, the neural network further comprises a second convolution layer configured to adjust the feature maps output by the first addition block to a number of predefined classes.

In an embodiment, the first convolution layer and/or the second convolution layer have a 1×1 convolution kernel.

In an embodiment, the neural network may further comprise a second upsampling block configured to upsample the feature maps output by the second convolution layer.

In an embodiment, the neural network may further comprise a softmax layer configured to get a prediction from the output feature maps of the image.

In an embodiment, the method may further comprise training the neural network by a back-propagation algorithm.

In an embodiment, the method may further comprise enhancing the image.

In an embodiment, the first and second input feature maps of the image may be obtained from another neural network.

In an embodiment, the neural network is used for at least one of image classification, object detection and semantic segmentation.

According to another aspect of the disclosure, it is provided an apparatus. The apparatus may comprise at least one processor; and at least one memory including computer program code, the memory and the computer program code configured to, working with the at least one processor, cause the apparatus to process, by using a neural network, first input feature maps of an image to obtain output feature maps of the image. The neural network may comprise at least two branches and a first addition block, each of the at least two branches comprises at least one first dilated convolution layer, at least one first upsampling block and at least one second addition block, a dilated rate of the first dilated convolution layer in an branch is different from that in another branch, the at least one first upsampling block is configured to upsample the first input feature maps or the feature maps output by the at least one second addition block, the at least one second addition block is configured to add the upsampled feature maps with second input feature maps of the image respectively, the first addition block is configured to add the feature maps output by each of the at least two branches, the first dilated convolution layer has one convolution kernel and an input channel of the first dilated convolution layer performs dilated convolution separately as an output channel of the first dilated convolution layer.

According to still another aspect of the present disclosure, it is provided a computer program product embodied on a distribution medium readable by a computer and comprising program instructions which, when loaded into a computer, causes a processor to process, by using a neural network, first input feature maps of an image to obtain output feature maps of the image. The neural network may comprise at least two branches and a first addition block, each of the at least two branches comprises at least one first dilated convolution layer, at least one first upsampling block and at least one second addition block, a dilated rate of the first dilated convolution layer in an branch is different from that in another branch, the at least one first upsampling block is configured to upsample the first input feature maps or the feature maps output by the at least one second addition block, the at least one second addition block is configured to add the upsampled feature maps with second input feature maps of the image respectively, the first addition block is configured to add the feature maps output by each of the at least two branches, the first dilated convolution layer has one convolution kernel and an input channel of the first dilated convolution layer performs dilated convolution separately as an output channel of the first dilated convolution layer.

According to still another aspect of the present disclosure, it is provided a non-transitory computer readable medium having encoded thereon statements and instructions to cause a processor to process, by using a neural network, first input feature maps of an image to obtain output feature maps of the image. The neural network may comprise at least two branches and a first addition block, each of the at least two branches comprises at least one first dilated convolution layer, at least one first upsampling block and at least one second addition block, a dilated rate of the first dilated convolution layer in an branch is different from that in another branch, the at least one first upsampling block is configured to upsample the first input feature maps or the feature maps output by the at least one second addition block, the at least one second addition block is configured to add the upsampled feature maps with second input feature maps of the image respectively, the first addition block is configured to add the feature maps output by each of the at least two branches, the first dilated convolution layer has one convolution kernel and an input channel of the first dilated convolution layer performs dilated convolution separately as an output channel of the first dilated convolution layer.

According to still another aspect of the present disclosure, it is provided an apparatus comprising means configured to process, by using a neural network, first input feature maps of an image to obtain output feature maps of the image. The neural network may comprise at least two branches and a first addition block, each of the at least two branches comprises at least one first dilated convolution layer, at least one first upsampling block and at least one second addition block, a dilated rate of the first dilated convolution layer in an branch is different from that in another branch, the at least one first upsampling block is configured to upsample the first input feature maps or the feature maps output by the at least one second addition block, the at least one second addition block is configured to add the upsampled feature maps with second input feature maps of the image respectively, the first addition block is configured to add the feature maps output by each of the at least two branches, the first dilated convolution layer has one convolution kernel and an input channel of the first dilated convolution layer performs dilated convolution separately as an output channel of the first dilated convolution layer.

These and other objects, features and advantages of the disclosure will become apparent from the following detailed description of illustrative embodiments thereof, which is to be read in connection with the accompanying drawings.

### BRIEF DESCRIPTION OF THE DRAWINGS

FIG. 1 schematically shows an application of scene segmentation on autonomous vehicle;

FIG. 2(a) schematically shows a Pyramid Scene Parsing (PSP) network;

FIG. 2(b) schematically shows an Atrous Spatial Pyramid Pooling (ASPP) network;

FIG. 3a is a simplified block diagram showing an apparatus in which various embodiments of the disclosure may be implemented;

FIG. 3b is a simplified block diagram showing a vehicle according to an embodiment of the disclosure;

FIG. 3c is a simplified block diagram showing a video surveillance system according to an embodiment of the disclosure;

FIG. 4 schematically shows architecture of the RSPP network according to an embodiment of the present disclosure;

FIG. 5 schematically shows architecture of the RSPP network according to another embodiment of the present disclosure;

FIG. 6 schematically shows specific operations of the depth-wise convolution;

FIG. 7a schematically shows architecture of a neural network according to an embodiment of the present disclosure;

FIG. 7b schematically shows architecture of a neural network according to another embodiment of the present disclosure;

FIG. 7c schematically shows architecture of a neural network according to another embodiment of the present disclosure;

FIG. 8 is a flow chart depicting a method according to an embodiment of the present disclosure;

FIG. 9 is a flow chart depicting a method according to another embodiment of the present disclosure;

FIG. 10 shows a neural network according to an embodiment of the disclosure;

FIG. 11 shows an example of segmentation results on CamVid dataset; and

FIG. 12 shows an experimental result on Pascal VOC2012.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement. Various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

It is noted that though the embodiments are mainly described in the context of semantic segmentation, they are not limited to this but can be applied to various vision tasks that can benefit from the embodiments as described herein, such as image classification, object detection, etc.

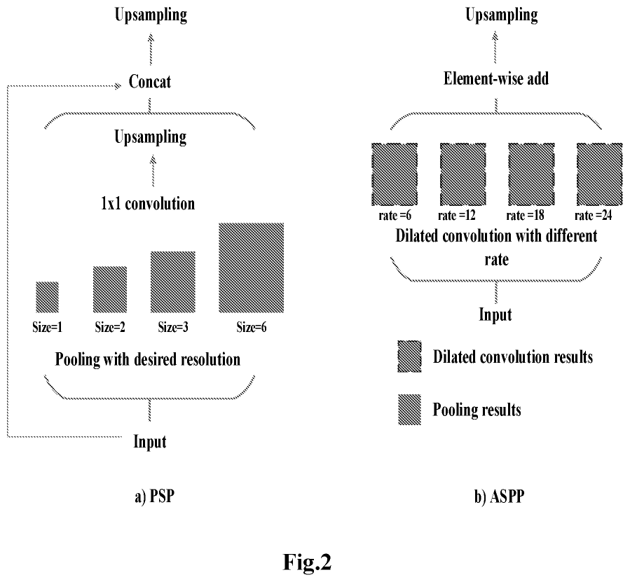

FIG. 2(a) shows a Pyramid Scene Parsing (PSP) network proposed by H. Zhao, J. Shi, X. Qi, X. Wang and J. Jia, “Pyramid Scene Parsing Network,” in Proceedings of the IEEE Conference on Computer Vision and Pattern Recognition, pp. 6230-6239, 2017, which is incorporated herein by reference in its entirety. The PSP network performs pooling operations at different stride to obtain features of different receptive field, and then adjusts their channels via a 1×1 convolution layer, finally upsamples them to an input feature maps resolution and concatenate with input feature maps. Different receptive fields information may be probed through this PSP network. However, apart from the problems stated above, there is a problem that the PSP network requires a fixed-size input, which may make the application of PSP network more difficult.

FIG. 2(b) shows an Atrous Spatial Pyramid Pooling (ASPP) network proposed by L. C. Chen, G. Papandreou, I. Kokkinos, K. Murphy and A. L. Yuille, “DeepLab: Semantic Image Segmentation with Deep Convolutional Nets, Atrous Convolution, and Fully Connected CRFs,” IEEE Transactions on Pattern Analysis and Machine Intelligence, 2018, which is incorporated herein by reference in its entirety. ASPP network uses four different rates (i.e., 6, 12, 18, 24) of dilated convolution in parallel. The receptive fields may be controlled via setting the rate of dilated convolution. Therefore, fusing the results of four dilated convolution layers will get better extracted features without extra requirements as the PSP network. Although ASPP network has achieved a great success, it suffers from the problems stated above, which limit its performance.

$$( \frac{H}{8} \times \frac{W}{8} \times {C}_{1} )$$

As shown in FIG. 2(b), input feature maps which may be obtained from a base network such as neural network are firstly fed into four parallel dilated convolution (also referred to as atrous convolution) layers. Parameters H, W, C denotes the height of an original input image, the width of the original input image, and the channel numbers of the feature maps respectively. The four parallel dilated convolution layers with different dilated rates can extract features under different receptive field (using different dilated rates to control the receptive field may be better than using different pooling strides in the original SPP network). The outputs

$$( \frac{H}{8} \times \frac{W}{8} \times {C}_{2} )$$

of the four parallel dilated convolution layers are fed into an element-wise adding layer to aggregate information under different receptive field. A parameter C₂ denotes a number of the classes of the scenes/objects in the input image. In order to accomplish pixel-level semantic segmentation, the aggregated feature maps are directly upsampled by a factor of 8, now the resolution of the upsampled feature maps (H×W) is equal to the resolution of the original input image, and the upsampled feature maps can be fed into a softmax layer to get the prediction.

ASPP network uses four parallel convolution layers and a set of dilated rates (6, 12, 18, 24) to extract better feature maps. However, there may be some drawbacks of ASPP network: ASPP network extracts feature maps only at low resolutions, and the direct upsampling factor (i.e., 8) is large. Therefore, the output feature maps are not optimization; there are too many parameters in ASPP which may easily cause overfitting; and ASPP does not fully utilize object detailed information.

To overcome at least one of the above problems or other problems, embodiments of the present disclosure propose a neural network termed as RSPP network. RSPP may extract features from low-resolution progressive to high-resolution, then upsampling them by a smaller factor (for example, 4).

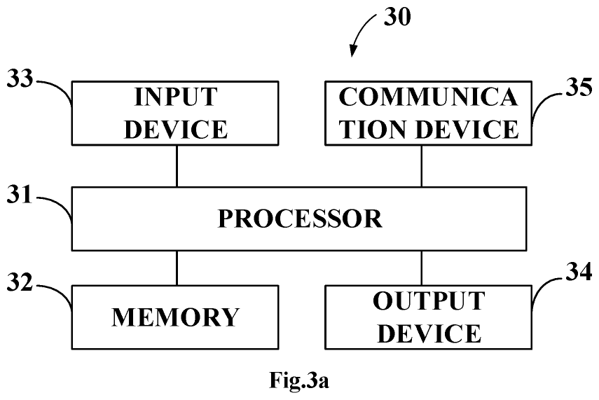

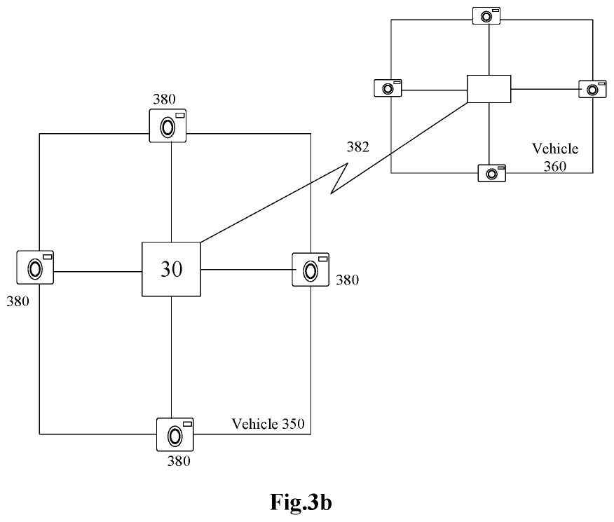

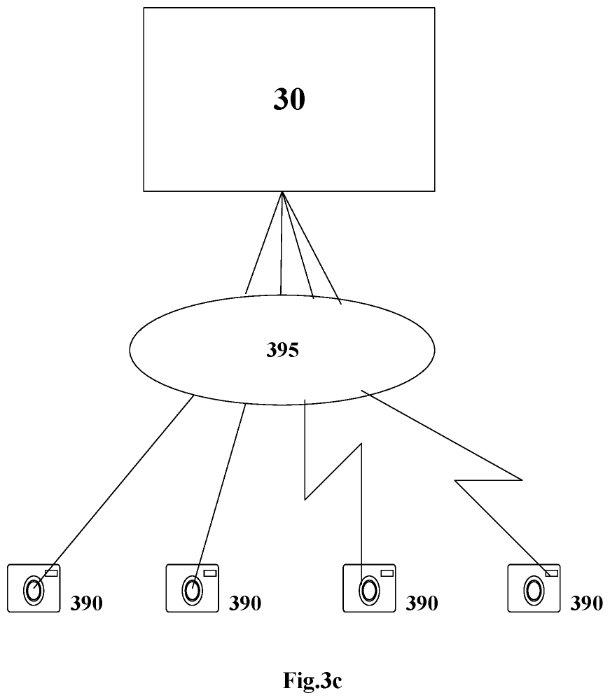

FIG. 3a is a simplified block diagram showing an apparatus, such as an electronic apparatus 30, in which various embodiments of the disclosure may be applied. It should be understood, however, that the electronic apparatus as illustrated and hereinafter described is merely illustrative of an apparatus that could benefit from embodiments of the disclosure and, therefore, should not be taken to limit the scope of the disclosure. While the electronic apparatus 30 is illustrated and will be hereinafter described for purposes of example, other types of apparatuses may readily employ embodiments of the disclosure. The electronic apparatus 30 may be a user equipment, a mobile computer, a desktop computer, a laptop computer, a mobile phone, a smart phone, a tablet, a server, a cloud computer, a virtual server, a computing device, a distributed system, a video surveillance apparatus such as surveillance camera, a HMI apparatus, ADAS, UAS, a camera, glasses/goggles, a smart stick, smart watch, necklace or other wearable devices, an Intelligent Transportation System(ITS), a police information system, a gaming device, an apparatus for assisting people with impaired visions and/or any other types of electronic systems. The electronic apparatus 30 may run with any kind of operating system including, but not limited to, Windows, Linux, UNIX, Android, iOS and their variants. Moreover, the apparatus of at least one example embodiment need not to be the entire electronic apparatus, but may be a component or group of components of the electronic apparatus in other example embodiments.

In an embodiment, the electronic apparatus 30 may comprise processor 31 and memory 32. Processor 31 may be any type of processor, controller, embedded controller, processor core, graphics processing unit (GPU) and/or the like. In at least one example embodiment, processor 31 utilizes computer program code to cause an apparatus to perform one or more actions. Memory 32 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 32 may store any of a number of pieces of information, and data. The information and data may be used by the electronic apparatus 30 to implement one or more functions of the electronic apparatus 30, such as the functions described herein. In at least one example embodiment, memory 32 includes computer program code such that the memory and the computer program code are configured to, working with the processor, cause the apparatus to perform one or more actions described herein.

The electronic apparatus 30 may further comprise a communication device 35. In at least one example embodiment, communication device 35 comprises an antenna, (or multiple antennae), a wired connector, and/or the like in operable communication with a transmitter and/or a receiver. In at least one example embodiment, processor 31 provides signals to a transmitter and/or receives signals from a receiver. The signals may comprise signaling information in accordance with a communications interface standard, user speech, received data, user generated data, and/or the like. Communication device 35 may operate with one or more air interface standards, communication protocols, modulation types, and access types. By way of illustration, the electronic communication device 35 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 35 may operate in accordance with wireline protocols, such as Ethernet, digital subscriber line (DSL), and/or the like.

Processor 31 may comprise means, such as circuitry, for implementing audio, video, communication, navigation, logic functions, and/or the like, as well as for implementing embodiments of the disclosure including, for example, one or more of the functions described herein. For example, processor 31 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 30 among these devices according to their respective capabilities. The processor 31 thus may comprise the functionality to encode and interleave message and data prior to modulation and transmission. The processor 31 may additionally comprise an internal voice coder, and may comprise an internal data modem. Further, the processor 31 may comprise functionality to operate one or more software programs, which may be stored in memory and which may, among other things, cause the processor 31 to implement at least one embodiment including, for example, one or more of the functions described herein. For example, the processor 31 may operate a connectivity program, such as a conventional internet browser. The connectivity program may allow the electronic apparatus 30 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 30 may comprise a user interface for providing output and/or receiving input. The electronic apparatus 30 may comprise an output device 34. Output device 34 may comprise an audio output device, such as a ringer, an earphone, a speaker, and/or the like. Output device 34 may comprise a tactile output device, such as a vibration transducer, an electronically deformable surface, an electronically deformable structure, and/or the like. Output Device 34 may comprise a visual output device, such as a display, a light, and/or the like. The electronic apparatus may comprise an input device 33. Input device 33 may comprise a light sensor, a proximity sensor, a microphone, a touch sensor, a force sensor, a button, a keypad, a motion sensor, a magnetic field sensor, a camera, a removable storage device and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like.

The electronic apparatus 30 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

Input device 33 may comprise an image capturing element. The image capturing element may be any means for capturing an image(s) for storage, display or transmission. For example, in at least one example embodiment, the image capturing element is an imaging sensor. As such, the image capturing element may comprise hardware and/or software necessary for capturing the image. In addition, input device 33 may comprise any other elements such as a camera module.

In an embodiment, the electronic apparatus 30 may be comprised in a vehicle. FIG. 3b is a simplified block diagram showing a vehicle according to an embodiment of the disclosure. As shown in FIG. 3b, the vehicle 350 may comprise one or more image sensors 380 to capture one or more images around the vehicle 350. For example, the image sensors 380 may be installed at any suitable locations such as the front, the top, the back and/or the side of the vehicle. The image sensors 380 may have night vision functionality. The vehicle 350 may further comprise the electronic apparatus 30 which may receive the images captured by the one or more image sensors 380. Alternatively the electronic apparatus 30 may receive the images from another vehicle 360 for example by using vehicular networking technology (i.e., communication link 382). The image may be processed by using the method of the embodiments of the disclosure.

For example, the electronic apparatus 30 may be used as ADAS or a part of ADAS to understand/recognize one or more scenes/objects such as available road, lanes, lamps, persons, traffic signs, building, etc. The electronic apparatus 30 may segment scene/object in the image into regions with classes such as sky, building, pole, road marking, road, pavement, tree, sign symbol, fence, vehicle, pedestrian, and bike according to embodiments of the disclosure. Then the ADAS can take proper driving operation according to recognition results.

In another example, the electronic apparatus 30 may be used as a car security system to understand/recognize an object such as people. The electronic apparatus 30 may segment scene/object in the image into regions with a class such as people according to an embodiment of the disclosure. Then the car security system can take one or more proper operations according to recognition results. For example, the car security system may store and/or transmit the captured image, and/or start anti-theft system and/or trigger an alarm signal, etc. when the captured image including the object of people.

In another embodiment, the electronic apparatus 30 may be comprised in a video surveillance system. FIG. 3c is a simplified block diagram showing a video surveillance system according to an embodiment of the disclosure. As shown in FIG. 3c, the video surveillance system may comprise one or more image sensors 390 to capture one or more images at different locations. For example, the image sensors may be installed at any suitable locations such as the traffic arteries, public gathering places, hotels, schools, hospitals, etc. The image sensors may have night vision functionality. The vehicle may further comprise the electronic apparatus 30 such as a server which may receive the images captured by the one or more image sensors 390 though a wired and/or wireless network 395. The images may be processed by using the method of the embodiments of the disclosure. Then the video surveillance system may utilize the processed image to perform any suitable video surveillance task.

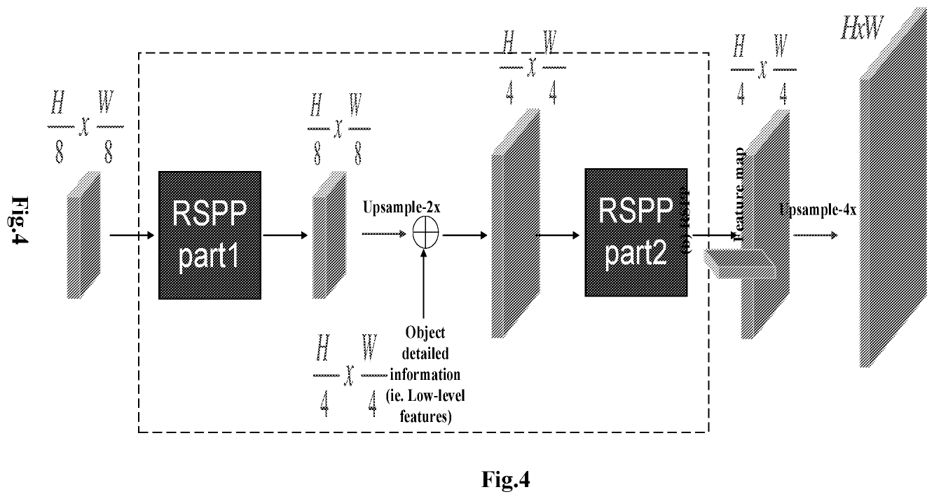

FIG. 4 schematically shows architecture of the RSPP network according to an embodiment of the present disclosure. As shown in FIG. 4, the feature maps such as

$$\frac{H}{8} \times \frac{W}{8}$$

of an image are fed into the RSPP network. The feature maps may be obtained by using various approaches such as another neural network, for example, ResNet, DenseNet, Xception, VGG, etc. In RSPP part1, the feature extraction is performed at a low resolution, i.e.,

$$\frac{H}{8} \times \frac{W}{8}$$

in this embodiment. And then, the feature maps are upsampled for example via bilinear interpolation by a factor of 2 or any other suitable value to get feature maps at a high resolution such as

$$( \frac{H}{4} \times \frac{W}{4} ) .$$

The upsampled feature maps are element-wise added with object detailed information such as low-level features of the image, and then the outputs are feed into RSPP part2 to perform feature extraction at a high resolution, i.e.,

$$\frac{H}{4} \times \frac{W}{4}$$

in this embodiment. Then the feature maps such as

$$( \frac{H}{4} \times \frac{W}{4} )$$

are upsampled by a proper factor such as 4 or any other suitable value to obtain the feature maps such as (H×W) for prediction. By using RSPP, features of the image at high resolution and low resolution can be extracted, which may obtain better extracted features.

Although parallel dilated convolution can effectively control receptive fields, it also increases excessive parameters, resulting in decreasing the performance of the neural network. Therefore, it is beneficial to reduce the parameters. There may be various ways to reduce the parameters in RSPP, such as 1×1 convolutional layer, depth-wise convolution, etc.

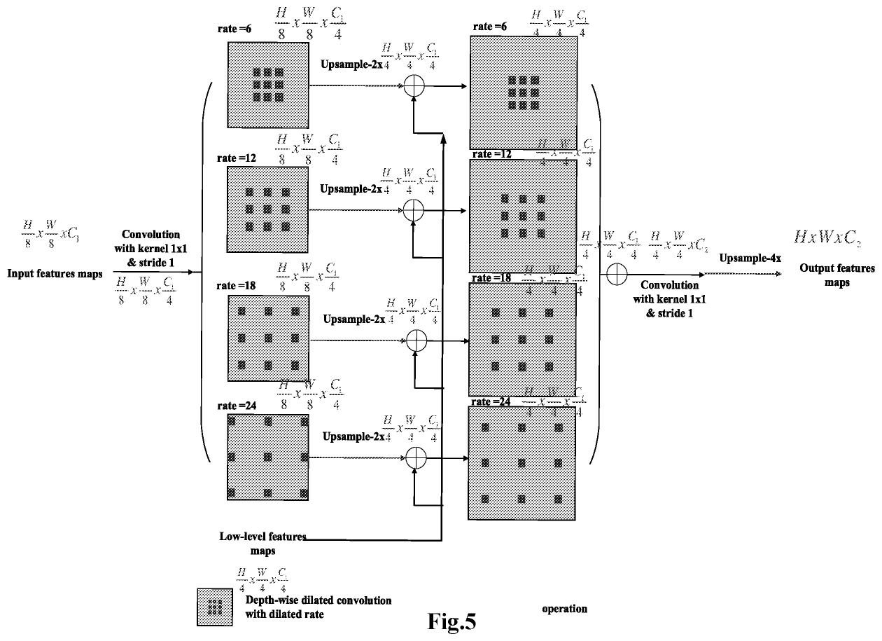

FIG. 5 schematically shows architecture of the RSPP network according to another embodiment of the present disclosure. As shown in FIG. 5, RSPP network may use a 1×1 convolutional layer to reduce the number of channels of the input feature maps.

The 1×1 convolutional layer may be used to process the input feature maps of the image to reduce the number of channels of the input feature maps. The number of channels of the input feature maps may be reduced to any suitable number. For example, the number of the reduced channels

$$( \frac{{C}_{1}}{4} )$$

may be set to one quarter of the number of the channels of the input feature maps (C₁). As shown in FIG. 5, there are four branches, and the reduced channels

$$( \frac{{C}_{1}}{4} )$$

are tea into the tour branches respectively.

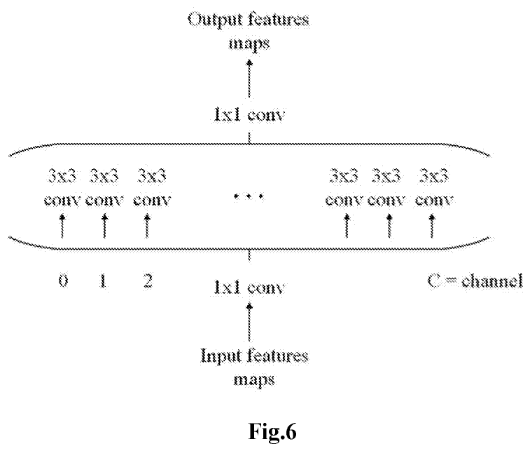

In each branch, the parameters can be further reduced by using a modified depth-wise convolution. FIG. 6 shows specific operations of the depth-wise convolution. As shown in FIG. 6, each channel of the input feature maps is convolved with one kernel separately, and then is merged via a 1×1 convolution layer. The amount of the parameters by using depth-wise convolution can be greatly reduced compared with the normal convolution. For example, assuming input channels are 2048, output channels are 21, and the convolution kernel is 3×3, then the amount of the parameters of normal convolution is 2048×21×3×3=368640, and for depth-wise convolution, the amount of the parameters is 2048×3×3+2048×21×1×1=61440. Therefore the depth-wise convolution can greatly reduce the parameters. The differences between the convolution layers in RSPP network and the depth-wise convolution lies in the fact that RSPP network integrates depth-wise convolution and dilated convolution which may be referred to as depth-wise dilated convolution herein. In RSPP network, the dilated convolution is performed for each input channel separately. Moreover different from the depth-wise convolution, after the dilated convolution, another 1×1 convolution layer may not be used to perform features fusion. Instead, the output of the dilated convolution may be upsampled and added with low-level feature maps, then fed into another dilated convolution layer. Finally, the 1×1 convolution may be performed to implement feature fusion after adding multi-scale receptive field features. The above operations can further reduce the parameters.

Pooling and upsampling operation can cause object information loss. The larger the stride of convolution, the more serious the loss of object information. In RSPP, feature maps may be extracted at a low-resolution such as

$$( \frac{H}{8} \times \frac{W}{8} \times \frac{{C}_{1}}{4} )$$

and then upsampled by a factor of integer such as 2 for feature extraction at a high resolution such as

$$( \frac{H}{4} \times \frac{W}{4} \times \frac{{C}_{1}}{4} )$$

to get better feature maps. However, the direct upsampling may lead to object information loss. In order to reduce the loss of object information, the upsampled feature maps may be element-wise added with the low-level feature maps which may contain more object detailed information (i.e., edge, contour, etc.) respectively to compensate for information loss and increase context information.

Turn to FIG. 5, the input feature maps such as

$$\frac{H}{8} \times \frac{W}{8} \times {C}_{1}$$

are fed into a 1×1 convolution layer to reduce the number of channels of the input feature maps. The obtained features such as

$$\frac{H}{8} \times \frac{W}{8} \times \frac{{C}_{1}}{4}$$

are fed into four parallel depth-wise dilated convolution layers with different dilated rates such as 6, 12, 18, 24, and the outputs such as

$$\frac{H}{8} \times \frac{W}{8} \times \frac{{C}_{1}}{4}$$

of these layers are upsampled to obtain high resolution features maps such as

$$\frac{H}{4} \times \frac{W}{4} \times \frac{{C}_{1}}{4} .$$

And men me nip resolution features maps may be element-wise added with low-level features such as

$$\frac{H}{4} \times \frac{W}{4} \times \frac{{C}_{1}}{4}$$

of the image which may be obtained by a neural network. The outputs such as

$$\frac{H}{4} \times \frac{W}{4} \times \frac{{C}_{1}}{4}$$

of the element-wise adding operation are fed into the other four parallel depth-wise dilated convolution layers with different dilated rates such as 6, 12, 18, 24. In this way, the features are extracted at high resolution. Then the outputs such as

$$\frac{H}{4} \times \frac{W}{4} \times \frac{{C}_{1}}{4}$$

of the later four parallel dilated convolution layers are element-wise added and then fed into a 1×1 convolution layer for information fusion, meanwhile the channel number after information fusion is adjusted to the number of class. Then the feature maps can be upsampled at a smaller factor such as 4 to get the final required feature maps (H×W×C₂). The low-level feature maps are not added here because it is the feature maps that are eventually used for prediction. It is noted that the upsampling factor, the number of times of upsampling, the number of parallel convolution layers and the dilated rate are not fixed and can be any suitable values in other embodiments.

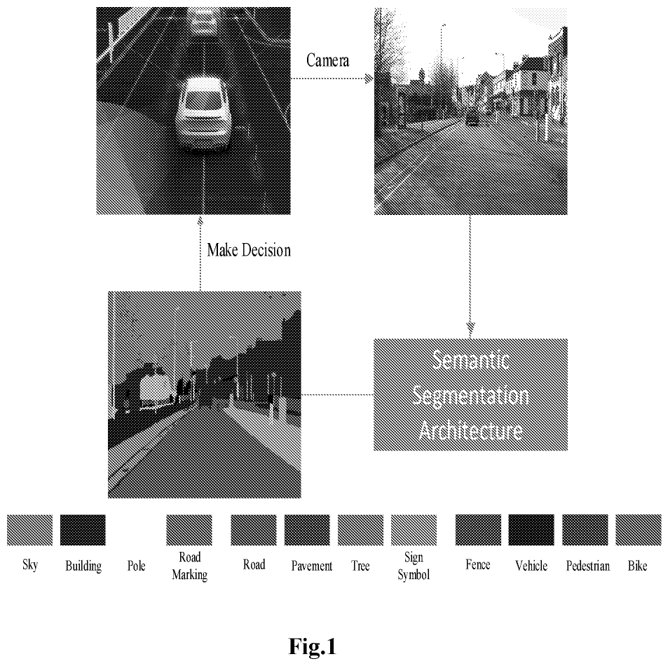

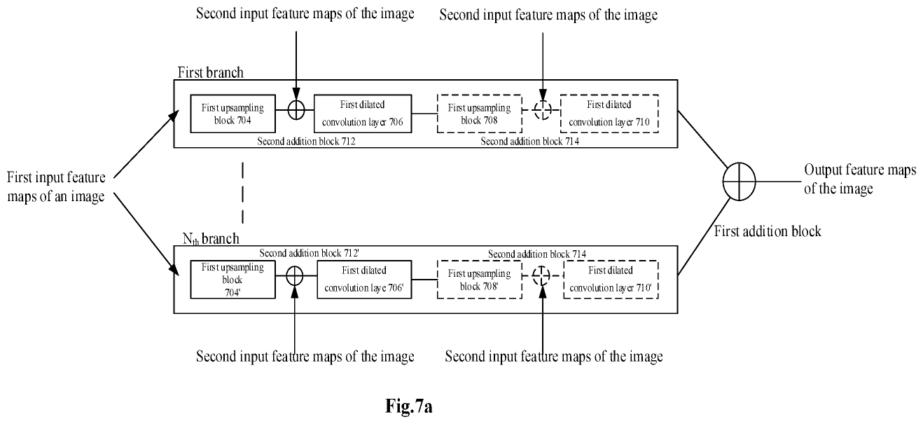

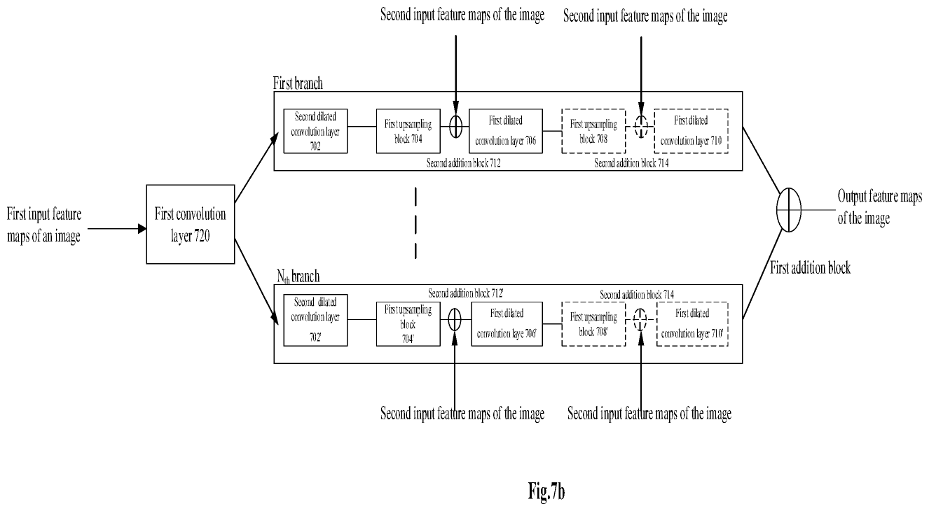

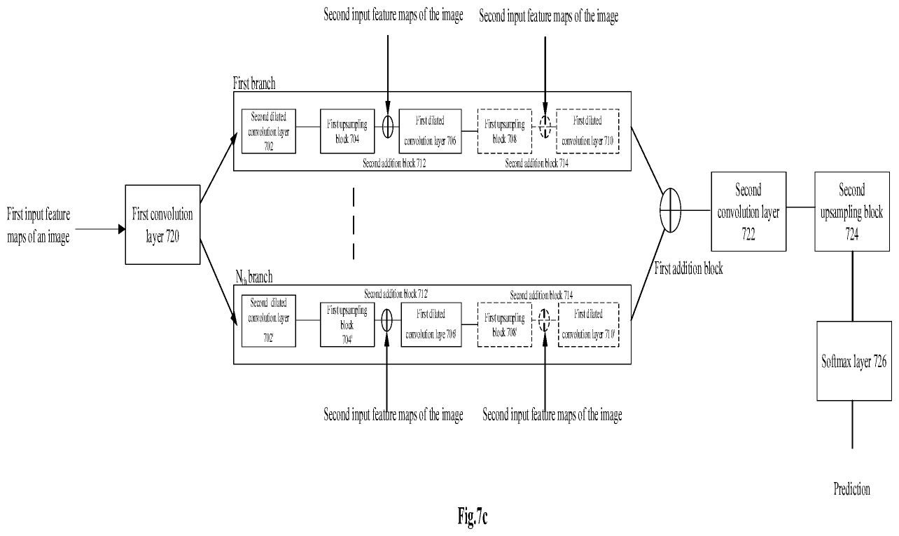

FIG. 7a schematically shows architecture of a neural network according to an embodiment of the present disclosure. The neural network may be similar to RSPP as described above. For some same or similar parts which have been described with respect to FIGS. 1-2, 3a, 3b, 3c, 4-6, the description of these parts is omitted here for brevity.

As shown in FIG. 7a, the neural network may comprise at least two branches and a first addition block. The number of the branches may be predefined, depend on a specific vision task, or determined by machine learning, etc. For example, the number of the branches may be 2, 3, 4 or any other suitable values. Each of the at least two branches may comprise at least one first dilated convolution layer, at least one first upsampling block and at least one second addition block. In an embodiment, the first branch may comprise the first dilated convolution layer 706, the first upsampling block 704 and the second addition block 712. In another embodiment, the first branch may comprise the first dilated convolution layers 706 and 710, the first upsampling blocks 704 and 708, and the second addition blocks 712 and 714. Note that there may be multiple first dilated convolution layers 710, multiple first upsampling blocks 708, and multiple second addition blocks 714 though only one first dilated convolution layers 710, one first upsampling blocks 708, and one second addition blocks 714 are shown in FIG. 7a.

A dilated rate of the first dilated convolution layer in a branch may be different from that in another branch. For example, the dilated rate of the first dilated convolution layer 706 in the first branch may be different from the dilated rate of the first dilated convolution layer 706′ in the Nₜₕ branch. The dilated rate of the first dilated convolution layer in each branch may be predefined, depend on a specific vision task, or determined by machine learning, etc. In general, the dilated rate of the first dilated convolution layer in each branch may be same. For example, the dilated rate of the first dilated convolution layers 706 and 710 in the first branch may be same. The first dilated convolution layer may have one convolution kernel and an input channel of the first dilated convolution layer may perform dilated convolution separately as an output channel of the first dilated convolution layer.

The first upsampling block may be configured to upsample the first input feature maps. The rate of upsampling may be predefined, depend on a specific vision task, or determined by machine learning, etc. For example, the rate of upsampling may be 2. The first input feature maps may be obtained by using various ways, for example, another neural network such as ResNet, DenseNet, Xception, VGG, etc.

The second addition block may be configured to add the upsampled feature maps with second input feature maps of the image respectively. As described above, in order to reduce the loss of object information, the upsampled feature maps may be element-wise added with the low-level feature maps (i.e., second input feature maps of the image) which may contain more object detailed information (i.e., edge, contour, etc.) respectively to compensate for information loss and increase context information. The resolution of the upsampled feature maps may be same as that of the second input feature maps of the image. The second input feature maps may be obtained by using various ways, for example, another neural network such as ResNet, DenseNet, Xception, VGG, etc.

The first addition block may be configured to add the feature maps output by each of the at least two branches. Each branch may output the same resolution of the feature maps, then the first addition block may add the feature maps output by the each of the at least two branches. For example, the first addition block may add the feature maps output by the first dilated convolution layer 710 and 710′.

In an embodiment, each of the at least two branches may further comprise a second dilated convolution layer 702 as shown in FIG. 7b. The second dilated convolution layer may be configured to process the first input feature maps and send its output feature maps to the first upsampling block. In this embodiment, the first upsampling block may be configured to upsample the first input feature maps output by the second dilated convolution layer. The second dilated convolution layer may have one convolution kernel and an input channel of the second dilated convolution layer may perform dilated convolution separately as an output channel of the second dilated convolution layer.

In an embodiment, the neural network may further comprise a first convolution layer 720 as shown in FIGS. 7b and 7c. The first convolution layer 720 may be configured to reduce a number of the first input feature maps. For example, the first convolution layer 720 may be a 1×1 convolution or any other suitable convolution.

In an embodiment, the neural network may further comprise a second convolution layer 722 as shown in FIG. 7c. The second convolution layer 722 may be configured to adjust the feature maps output by the first addition block to a number of predefined classes. The second convolution layer 722 may be a 1×1 convolution or any other suitable convolution. For example, suppose there are 12 classes such as sky, building, pole, road marking, road, pavement, tree, sign symbol, fence, vehicle, pedestrian, and bike, then the second convolution layer 722 may adjust the feature maps output by the first addition block to 12.

In an embodiment, the neural network may further comprise a second upsampling block 724 as shown in FIG. 7c. The second upsampling block 724 may be configured to upsample the feature maps output by the second convolution layer 722 to a predefined size. For example, the size of the output feature maps of the last layer of the neural network may be adjusted to be equal to the size of the original input images so that softmax operation can be conducted for pixel-wise semantic segmentation.

In an embodiment, the neural network further comprises a softmax layer 726 as shown in FIG. 7c. The softmax layer 726 may be configured to get a prediction from the output feature maps of the second upsampling block 724.

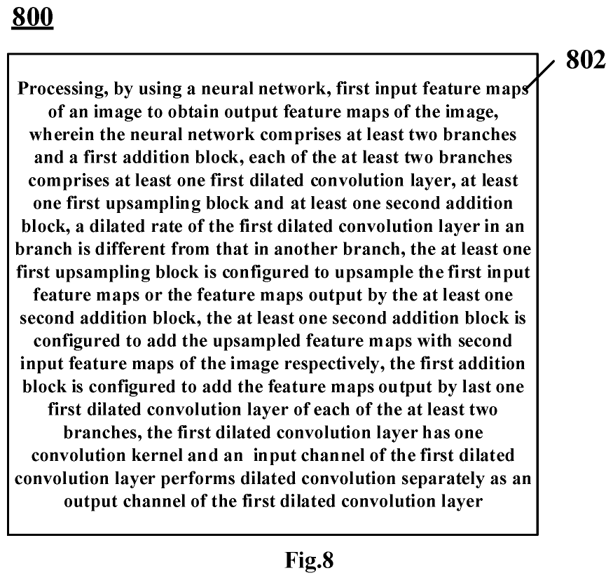

FIG. 8 is a flow chart depicting a method according to an embodiment of the present disclosure. The method 800 may be performed at an apparatus such as the electronic apparatus 30 of FIG. 3a. As such, the apparatus may provide means for accomplishing various parts of the method 800 as well as means for accomplishing other processes in conjunction with other components. For some same or similar parts which have been described with respect to FIGS. 1-2, 3a, 3b, 3c, 4-6, 7a, 7b and 7c, the description of these parts is omitted here for brevity.

As shown in FIG. 8, the method 800 may start at block 802 where the electronic apparatus 30 may process, by using a neural network, first input feature maps of an image to obtain output feature maps of the image. The neural network may be the neural network as described with reference to FIGS. 7a, 7b and 7c. As described above, the neural network may comprise at least two branches and a first addition block. Each of the at least two branches may comprise at least one first dilated convolution layer, at least one first upsampling block and at least one second addition block, a dilated rate of the first dilated convolution layer in an branch is different from that in another branch, the at least one first upsampling block is configured to upsample the first input feature maps or the feature maps output by the at least one second addition block, the at least one second addition block is configured to add the upsampled feature maps with second input feature maps of the image respectively, the first addition block is configured to add the feature maps output by each of the at least two branches, the first dilated convolution layer has one convolution kernel and an input channel of the first dilated convolution layer performs dilated convolution separately as an output channel of the first dilated convolution layer.

In an embodiment, each of the at least two branches further comprises a second dilated convolution layer configured to process the first input feature maps and send its output feature maps to the first upsampling block, the second dilated convolution layer has one convolution kernel and an input channel of the second dilated convolution layer performs dilated convolution separately as an output channel of the second dilated convolution layer.

In an embodiment, the neural network further comprises a first convolution layer configured to reduce a number of the first input feature maps.

In an embodiment, the neural network further comprises a second convolution layer configured to adjust the feature maps output by the first addition block to a number of predefined classes.

In an embodiment, the first convolution layer and/or the second convolution layer have a 1×1 convolution kernel.

In an embodiment, the neural network further comprises a second upsampling block configured to upsample the feature maps output by the second convolution layer.

In an embodiment, the neural network further comprises a softmax layer configured to get a prediction from the output feature maps of the image.

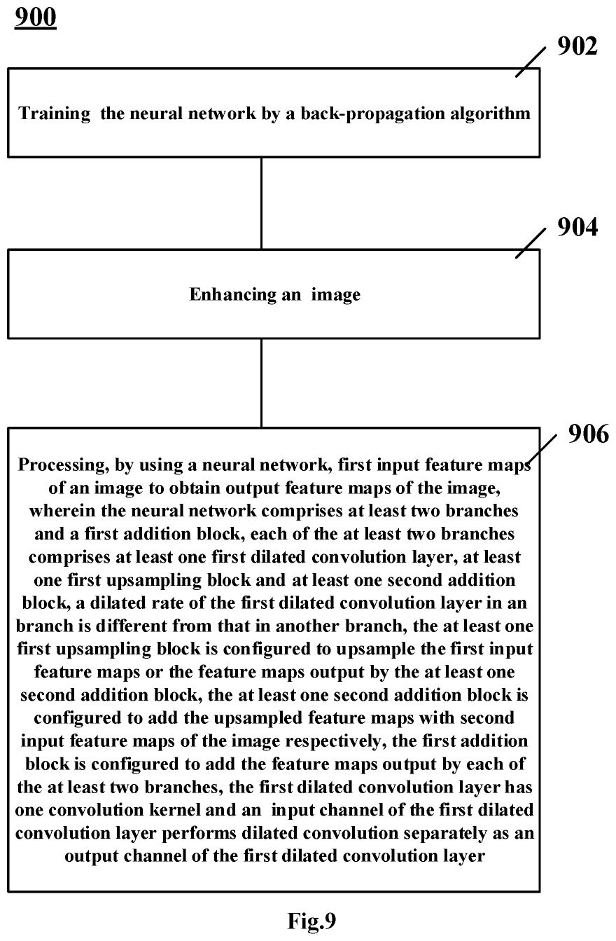

FIG. 9 is a flow chart depicting a method according to an embodiment of the present disclosure. The method 900 may be performed at an apparatus such as the electronic apparatus 30 of FIG. 3a. As such, the apparatus may provide means for accomplishing various parts of the method 900 as well as means for accomplishing other processes in conjunction with other components. For some same or similar parts which have been described with respect to FIGS. 1-2, 3a, 3b, 3c, 4-6, 7a, 7b, 7c and 8, the description of these parts is omitted here for brevity. Block 906 is similar to block 802 of FIG. 8, therefore the description of this step is omitted here for brevity.

As shown in FIG. 9, the method 900 may start at block 902 where the electronic apparatus 30 may train the neural network by a back-propagation algorithm. A training stage may comprise the following steps:

(1) Preparing a set of training images and their corresponding ground truth. The ground truth of an image indicates the class label of each pixel.
(2) Specifying the number of layers of a base neural network and output stride of the base neural network, wherein the base neural network may be configured to generate the feature maps of an image as the input of the proposed neural network. Specifying the dilated rate and upsampling stride of the proposed neural network such as RSPP.
(3) With the training images and their ground truth, training the proposed neural network by a standard back-propagation algorithm. When the algorithm converges, the trained parameters of the proposed neural network can be used for segmenting an image

At block 904, the electronic apparatus 30 may enhance the image. For example, image enhancement may comprise removing noise, sharpening, or brightening the image, making the image easier to identify key features, etc.

In an embodiment, the first and second input feature maps of the image may be obtained from another neural network.

In an embodiment, the neural network may be used for at least one of image classification, object detection and semantic segmentation or any other suitable vision task which can benefit from the embodiments as described herein.

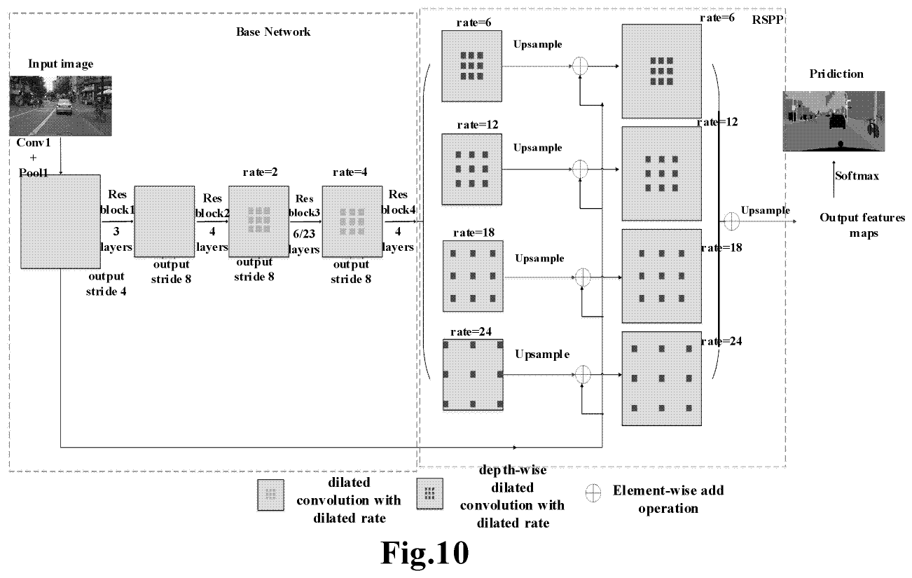

FIG. 10 shows a neural network according to an embodiment of the disclosure. This neural network may be used for semantic segmentation. As shown in FIG. 10, the base network comprises resnet-101 and resnet-50. The low-level feature maps come from res blockl, for the resolution here is not much smaller than the original image, so the information loss is small. The input image is fed into the base network. The outputs of the base network are fed into the proposed neural network.

The CamVid road scene dataset (G. Brostow, J. Fauqueur, and R. Cipolla, “Semantic object classes in video: A high-definition ground truth database,” PRL, vol. 30(2), pp. 88-97, 2009) and Pascal VOC2012 dataset (Pattern Analysis, Statistical Modeling and Computational Learning, http://host.robots.ox.ac.uk/pascal/VOC/) are used for evaluation. The method of embodiments of present disclosure is compared with the DeepLab-v2 method (L. C. Chen, G. Papandreou, I. Kokkinos, K. Murphy and A. L. Yuille, “DeepLab: Semantic Image Segmentation with Deep Convolutional Nets, Atrous Convolution, and Fully Connected CRFs,” IEEE Transactions on Pattern Analysis and Machine Intelligence, 2018).

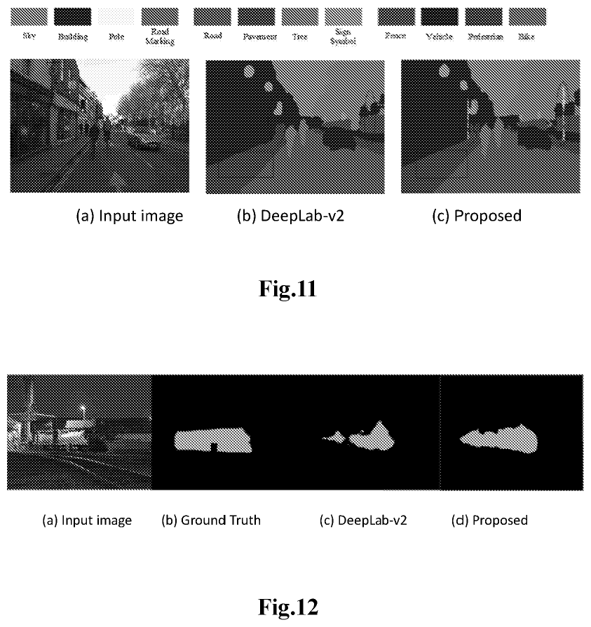

FIG. 11 shows an example of segmentation results on CamVid dataset. FIG. 11 (a) is the input image to be segmented. FIG. 11(b) and FIG. 11(c) are the segmentation results of the DeepLab-v2 method and the proposed method, respectively. One can see that proposed method (FIG. 11(c)) is better than DeepLab-v2 method (FIG. 11(b)). For example, the left and the right (the tiled ellipse) of FIG. 11(b) shows that the DeepLab-v2 method makes large error in classifying the pole. For driving, this error may cause fatal accident. FIG. 11(c) shows that the proposed method can remarkably reduce the error. In addition, the proposed method is more precise than the DeepLab-v2 in classifying the edge of pavement, road, etc. (see the rectangles in the bottom and the left rectangles of FIG. 11(c) and FIG. 11(b)).

FIG. 12 shows an experimental result on Pascal VOC2012. FIG. 12(a) is the input image to be segmented. FIG. 12(b), FIG. 12(c) and FIG. 12(d) are ground truth, the segmentation results of the DeepLab-v2 method and the proposed method, respectively. Comparing FIG. 12(c) with FIG. 12(d), one can found the proposed outperforms the DeepLab-v2 method. FIG. 12(d) is not only more accurate but also more continuous than FIG. 12(c).

Table.1. shows experimental mIoU (mean Intersection-over-union) criteria for evaluation of semantic segmentation, on Pascal VOC2012 dataset and CamVid dataset. The higher mIoU, the better performance. As can be seen from Table.1, the proposed method greatly improves the performance of scene segmentation and is therefore helpful for high performance application. In addition, the proposed method can achieve better performance only using simple deep convolution network. It can be found in the red regions of Table. 1. The advantage will make the proposed method meet higher performance and real-time requirement simultaneously in the practical application.

TABLE 1

| | Base network | Pascal VOC2012 | Camvid |
|---|---|---|---|
| DeepLab- | Resnet-50 | 70.8 | 61.1 |
| v2 | Resnet-101 | 75.1 | 63.6 |
| Proposed | Resnet-50 | 75.2 | 63.9 |
| method | Resnet-101 | 77.1 | 65.6 |

By using the proposed neural network according to embodiments of the present disclosure, the excessive parameters and information redundancy can be alleviated and it is more practical for Artificial Intelligence. Besides, the proposed method can achieve better performance using a simple base network than the one based on ASPP with deeper network, its more applicable to reality. In addition, the proposed method has higher segmentation accuracy and robust visual effect.

It is noted that any of the components of the apparatus described above can be implemented as hardware or software modules. In the case of software modules, they can be embodied on a tangible computer-readable recordable storage medium. All of the software modules (or any subset thereof) can be on the same medium, or each can be on a different medium, for example. The software modules can run, for example, on a hardware processor. The method steps can then be carried out using the distinct software modules, as described above, executing on a hardware processor.

Additionally, an aspect of the disclosure can make use of software running on a general purpose computer or workstation. Such an implementation might employ, for example, a processor, a memory, and an input/output interface formed, for example, by a display and a keyboard. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. The processor, memory, and input/output interface such as display and keyboard can be interconnected, for example, via bus as part of a data processing unit. Suitable interconnections, for example via bus, can also be provided to a network interface, such as a network card, which can be provided to interface with a computer network, and to a media interface, such as a diskette or CD-ROM drive, which can be provided to interface with media.

Accordingly, computer software including instructions or code for performing the methodologies of the disclosure, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

As noted, aspects of the disclosure may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the disclosure may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

The flowchart and block diagrams in the figures illustrate the architecture, functionality, and operation of possible implementations of apparatus, methods and computer program products according to various embodiments of the disclosure. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein, two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical region (both visible and invisible), as several non-limiting and non-exhaustive examples.

In any case, it should be understood that the components illustrated in this disclosure may be implemented in various forms of hardware, software, or combinations thereof, for example, application specific integrated circuit(s) (ASICS), a functional circuitry, a graphics processing unit, an appropriately programmed general purpose digital computer with associated memory, and the like. Given the teachings of the disclosure provided herein, one of ordinary skill in the related art will be able to contemplate other implementations of the components of the disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

1-15. (canceled)

16. A method comprising:
processing, by using a neural network, first input feature maps of an image to obtain output feature maps of the image;
wherein the neural network comprises at least two branches and a first addition block, each of the at least two branches comprises at least one first dilated convolution layer, at least one first upsampling block and at least one second addition block,
a dilated rate of the first dilated convolution layer in an branch is different from that in another branch, the at least one first upsampling block is configured to upsample the first input feature maps or a feature maps output by the at least one second addition block,
the at least one second addition block is configured to add the upsampled feature maps with second input feature maps of the image respectively,
the first addition block is configured to add the feature maps output by each of the at least two branches.

17. The method according to claim 16, wherein each of the at least two branches further comprises a second dilated convolution layer configured to process the first input feature maps and send its output feature maps to the first upsampling block.

18. The method according to claim 16, wherein the neural network further comprises a first convolution layer configured to reduce a number of the first input feature maps.

19. The method according to claim 16, wherein the neural network further comprises a second convolution layer configured to adjust the feature maps output by the first addition block to a number of predefined classes.

20. The method according to claim 19, wherein the first convolution layer and/or the second convolution layer have a 1×1 convolution kernel.

21. The method according to claim 16, wherein the neural network further comprises a second upsampling block configured to upsample the feature maps output by the second convolution layer.

22. The method according to claim 16, wherein the neural network further comprises a softmax layer configured to get a prediction from the output feature maps of the image.

23. The method according to claim 16, further comprising:
training the neural network by a back-propagation algorithm.

24. The method according to claim 16, further comprising enhancing the image.

25. The method according to claim 16, wherein the first and second input feature maps of the image are obtained from another neural network.

26. The method according to claim 16, wherein the neural network is used for at least one of image classification, object detection or semantic segmentation.

27. An apparatus, comprising:
at least one processor;
at least one memory including computer program code, the memory and the computer program code configured to, working with the at least one processor, cause the apparatus to process, by using a neural network, first input feature maps of an image to obtain output feature maps of the image;
wherein the neural network comprises at least two branches and a first addition block, each of the at least two branches comprises at least one first dilated convolution layer, at least one first upsampling block and at least one second addition block,
a dilated rate of the first dilated convolution layer in an branch is different from that in another branch, the at least one first upsampling block is configured to upsample the first input feature maps or a feature maps output by the at least one second addition block,
the at least one second addition block is configured to add the upsampled feature maps with second input feature maps of the image respectively,
the first addition block is configured to add the feature maps output by each of the at least two branches.

28. The apparatus according to claim 27, wherein each of the at least two branches further comprises a second dilated convolution layer configured to process the first input feature maps and send its output feature maps to the first upsampling block.

29. The apparatus according to claim 27, wherein the neural network further comprises a first convolution layer configured to reduce a number of the first input feature maps.

30. The apparatus according to claim 27, wherein the neural network further comprises a second convolution layer configured to adjust the feature maps output by the first addition block to a number of predefined classes.

31. A non-transitory computer readable medium having encoded thereon statements and instructions to cause a processor to
process, by using a neural network, first input feature maps of an image to obtain output feature maps of the image;
wherein the neural network comprises at least two branches and a first addition block, each of the at least two branches comprises at least one first dilated convolution layer, at least one first upsampling block and at least one second addition block,
a dilated rate of the first dilated convolution layer in an branch is different from that in another branch, the at least one first upsampling block is configured to upsample the first input feature maps or a feature maps output by the at least one second addition block,
the at least one second addition block is configured to add the upsampled feature maps with second input feature maps of the image respectively,
the first addition block is configured to add the feature maps output by each of the at least two branches.

32. The non-transitory computer readable medium according to claim 31, wherein each of the at least two branches further comprises a second dilated convolution layer configured to process the first input feature maps and send its output feature maps to the first upsampling block.

33. The non-transitory computer readable medium according to claim 31, wherein the neural network further comprises a first convolution layer configured to reduce a number of the first input feature maps.

34. The non-transitory computer readable medium according to claim 31, wherein the neural network further comprises a second convolution layer configured to adjust the feature maps output by the first addition block to a number of predefined classes.
